(19) United States
(12) Patent Application Publication
(10) Pub. No.: US 2002/0073598 A1
(43) Pub. Date: Jun. 20, 2002

(54) Folding decoy

(76) Inventor: John M. Wright, Calhoun, KY (US)

Correspondence Address: Richard C. Litman, LITMAN LAW OFFICES, LTD., P.O. Box 15035, Arlington, VA, 22215, US

(21) Appl. No.: 10/003,250

(22) Filed: Dec. 6, 2001

Related U.S. Application Data
(60) Provisional application No. 60/255,079, filed on Dec. 14, 2000.

(51) Int. Cl. A01M 31/06

(52) U.S. Cl. 43/3

(57) ABSTRACT

A folding decoy or other representation is formed of a single sheet of laminated material having opposite face plies and a central core sandwiched therebetween. Preferably, a waterproof, plastic material having a corrugated core is used, but other laminated materials may also be used as desired. The decoy is formed by cutting out a planform silhouette and then making a series of scores which extend through one of the face plies and the core material, leaving the opposite face ply uncut. The scores are made from opposite sides of the sheet to provide for folding in either direction, as desired. A series of such scores may be made, with different scores providing for different folds in different directions and orientations. This allows a person to use a single decoy blank to form decoys having different postures as desired, to add greater realism to a group of decoys.

### CROSS-REFERENCE TO RELATED APPLICATION

This application claims the benefit of U.S. Provisional Patent Application Serial No. 60/255,079, filed Dec. 14, 2000.

### BACKGROUND OF THE INVENTION

1. Field of the Invention

The present invention relates generally to the fields of hunting, fishing, and trapping, and more specifically to various embodiments of folding decoys formed from a single sheet of laminated material having a core sandwiched between two opposed outer sheets, as well as a method of forming such decoys from such sheet material. The present decoy embodiments are formed by cutting out a silhouette or pattern as desired and making a series of scores through either the first or the second outer sheet and the core material, thereby allowing the laminate to fold in a direction away from the score. The folds allow the sheet to be folded to form a three dimensional model or decoy of a waterfowl or other animal as desired.

2. Description of Related Art

Hunting is a traditionally popular leisure time activity for many people, with interest in the sport extending back many generations to a time when hunting was important for placing food on the table of many individuals. While the sport is generally more of a hobby than a necessity, it is nevertheless still enjoyed by a large number of people.

Many persons take the sport sufficiently seriously as to spend a great deal of time studying the habits of the game they are seeking, and spending a great deal of money on various accessories, including realistic decoys, lures, etc. While these various decoys may be effective to a certain extent in certain environments and conditions, it has been found by many hunters that extremely realistic (and expensive) decoys do not provide the attraction for game that was initially hoped. Game animals generally first see a decoy or lure from a relatively long distance, and thus an extremely detailed decoy is unnecessary. This is particularly true of waterfowl and other birds. However, a game animal will quickly lose interest and/or become suspicious of any decoy which remains absolutely stationary for some period, particularly if several decoys having identical poses are positioned in an area.

Another problem with any decoys is that they are subjected to a relatively harsh environment, particularly for waterfowl decoys. Such decoys must be waterproof, and also must be quite durable, as they almost certainly are subject to a fair amount of wear and tear from transport in the bed of a pickup or other rough handling. As extremely realistic decoys are generally more easily damaged than other decoys, and are also generally more costly, it will be seen that a hunter can easily go through a considerable sum of money in the repair and replacement of decoys during a hunting season.

Accordingly, what is needed is a decoy which is generally representative of the species being hunted, without necessarily providing extreme accuracy and realism from a close distance. A decoy which provides a reasonably good profile representation, is generally sufficient to lure game animals within gun range. Such decoys may be constructed quite economically by a single sheet of laminated material according to the present invention, with appropriate markings being applied to add further realism. They are relatively light in weight, which with their surface area, provides some movement in light breezes to add further realism. As the present decoys are each formed of a single sheet pattern, they are also easily folded for transport and storage, thereby greatly reducing wear and tear on the decoys as well. By using a waterproof material, the decoys of the present invention provide all the required durability for the necessarily wet conditions encountered during waterfowl hunting, and yet are easily and economically replaced in the event of damage. A series of scores along and across the laminate from each side allows the sheet to be folded along the scores, to pose the decoy in different positions.

A discussion of the related art of which the present inventor is aware, and its differences and distinctions from the present invention, is provided below.

U.S. Pat. No. 74,458 issued on Feb. 11, 1868 to Nathaniel Wales, titled “Decoy-Bird,” describes a decoy having a solid, three dimensional body with a pair of remotely actuated wings formed of relatively thin, flat panels. Wales does not specify the material from which the wing panels are made. In any event, the multiple component construction, remotely actuated wings which extend generally normal to the body of the decoy, lack of ability to form the entire decoy from a single sheet of material, and lack of ability to reposition the head and neck of the decoy as desired for further realism, distinguish the Wales decoy from the present invention.

U.S. Pat. No. 529,463 issued on Nov. 20, 1894 to William W. Roberts, titled “Collapsible Decoy,” describes a structure having a central telescoping tube with a series of flexible wire stays extending from end to end. A flexible fabric cover is applied over the wire body members. The Roberts decoy is deployed by collapsing the central tube, thereby causing the wire body members to bow outwardly to provide shape to the overlying fabric cover. The neck is not formed as an extension of the same sheet material as the body, as in the present invention, but rather has a single wire spine surrounded by a fabric cover and stuffing for shape. The head is not adjustably positionable relative to the neck, but is a separate component which must be installed each time the decoy is deployed, unlike the case with the present decoy invention.

U.S. Pat. No. 547,032 issued on Oct. 1, 1895 to Joseph Ross, titled “Folding Decoy,” describes an expandable wire form having a buoyant base. The wire form is expanded to take on the general configuration of a waterfowl, with a fabric covering providing the outer appearance. None of the components of the Ross decoy can be adjusted to alter the pose or appearance of his decoy, as can be the case with the present decoy invention. The Ross decoy is thus more closely related to the decoy of the Roberts '463 U.S. Patent discussed above, than to the present invention.

U.S. Pat. No. 554,368 issued on Feb. 11, 1896 to William Kunselman, titled “Decoy,” describes a decoy formed primarily of sheet metal components. The body is rolled into an inverted, generally U-shaped configuration, with a removable sheet metal internal bulkhead or former provided to hold the shape of the outer panel. The head and neck are formed of single sheets of metal cut out and riveted together, unlike the folded configuration of the present decoy.

U.S. Pat. No. 575,283 issued on Jan. 12, 1897 to George K. Frantz, titled “Decoy,” describes a sheet metal construction in which the body is formed of a single sheet which is removably installable to extend upright from a horizontal float base. The head and neck is also a single sheet of material, which is pivotally secured to the body sheet for folding. No central folding along a longitudinal axis for three dimensional form is provided by Frantz, nor is any means of selectively folding the device along various score and fold lines to provide different poses.

U.S. Pat. No. 673,846 issued on May 7, 1901 to Henry A. Rauert, titled “Folding Decoy Duck,” describes a decoy formed of a series of flat sheets which are assembled in three mutually orthogonal axes to provide a three dimensional shape. The Rauert decoy more closely resembles the Frantz '283 decoy discussed above, than the present decoy invention, as the Rauert decoy is formed of multiple components and folds only by means of hinges joining various components.

U.S. Pat. No. 977,787 issued on Dec. 6, 1910 to Evan J. Davis, titled “Decoy,” describes a decoy formed basically of a pair of mutually orthogonal plates or sheets, which fold outwardly along the longitudinal axis of the body to lie in horizontal and vertical planes. The head and neck are pivotally attached to the vertical component, for folding for storage of the device. The Davis decoy thus more closely resembles the decoy of the Rauert '846 decoy discussed above, than the present decoy invention.

U.S. Pat. No. 1,062,713 issued on May 27, 1913 to William R. Johnson, titled “Decoy,” describes a decoy formed of a single ply of waterproofed cardboard, separated at the top and joined by common fold lines at the bottom. A buoyant sheet is inserted between the bottom edges of the two side panels and the upper edges are secured together for deployment of the Johnson decoy. Johnson does not describe the material from which his decoy is formed as being a laminated sheet of any sort, as is the case in the present decoy invention. Thus, it would not be possible to modify the Johnson decoy by cutting through one side of a laminate to provide a unidirectional fold line, as provided in the present decoy invention. In any event, Johnson does not teach such a construction, as the head and neck of his decoy are immovably fixed to the body, and cannot fold.

U.S. Pat. No. 1,571,711 issued on Feb. 2, 1926 to Clarence L. Dewey, titled “Decoy,” describes a decoy having a buoyant horizontal base with a body portion comprising a single sheet extending upwardly therefrom. The body and base have mutually cooperating slots for assembly to one another. No folding action of any component is provided; the pose of the Dewey decoy cannot be adjusted, once assembled. The Dewey decoy thus more closely resembles the decoy of the Frantz '283 U.S. Patent discussed further above, than the present decoy invention.

U.S. Pat. No. 2,237,897 issued on Apr. 8, 1941 to George W. Vos, titled “Foldable Sheet Material Cutouts,” describes a single sheet construction wherein a series of parallel fold pairs are formed across the body and base of the neck of an animal representation. Each fold pair is doubled over to form a pocket for the insertion of a tab extending from one side of the fold area. As Vos provides only parallel folds in each fold pair for the insertion of a tab therein to secure the two sides together, the various areas to each side of a fold pair cannot be adjusted angularly relative to one another to alter the angle of head relative to the neck, or neck relative to the body, as is the case with the present folding decoy invention. Moreover, the Vos construction requires the lower portions of the body to be assembled essentially in contact with one another, with the completed assembly having an essentially two dimensional shape, unlike the angularly spread first and second sides of the body, neck, and head components of the present decoy invention. In addition, Vos describes the material of his model only as being “cardboard, paper, or the like” (p. 1, col. 2, 1. 24). Vos teaches away from the use of a corrugated material for constructing his model. This is clear when considering that corrugated material is much more resistant to bending and folding across the corrugations than parallel to the corrugations. The legs extending downwardly from the body would not provide the required stiffness to support the model, if the corrugations were parallel to the body and across the legs. While one embodiment of the present invention provides for legs or similar orthogonal elongate extensions, the technique used to form such extensions from a flat pattern, is completely different than that used in the Vos model.

U.S. Pat. No. 2,466,626 issued on Apr. 5, 1949 to Joseph Valasek, titled “Collapsible Duck Decoy,” describes a decoy configuration more closely resembling that of the Johnson '713 U.S. Patent discussed further above, than the present decoy invention. The Valasek decoy includes a pair of symmetrical sides formed of sheet material, hinged to a buoyant base plate or sheet. A line and a series of eyes are provided between the sheets, to hold them together in a deployed configuration. Valasek does not provide any means for adjusting the position of the head and neck of his decoy to provide different poses, as provided by the present invention.

U.S. Pat. No. 2,489,271 issued on Nov. 29, 1949 to William G. Colgan, titled “Foldable Decoy,” describes a decoy formed of a single sheet of material, but having relatively complex fold patterns and a tab and slot arrangement for adjusting the neck angle relative to the body. The multiple folds of the Colgan decoy result in the body having a generally flat back portion with nearly vertical sides, unlike the generally inverted V-shape of the body portion of the present decoy. Moreover, the neck portion of the Colgan decoy has a box-like cross section when completed, unlike the inverted V-shape of the neck of the present decoy, which is essentially a continuation of the shape formed by folding the body portion. Also, while Colgan does provide for the adjustability of the neck of his decoy relative to the head, he does so by means of tabs and slots, rather than by means of selectively folding the base of the neck along predetermined one way folds, as provided by the present decoy invention. In addition, the wire leg supports of the Colgan decoy are secured to the decoy body in a completely different manner than that used in the present decoy invention.

U.S. Pat. No. 2,535,445 issued on Dec. 26, 1950 to William Miller et al., titled “Goose Decoy,” describes a standing decoy having a generally vertical component topped by a generally horizontal component, both formed of thin sheets of material. The neck is pivotally attached to the vertical body component. The result more closely resembles the decoys of the Frantz '283 and Davis '787 U.S. Patents, discussed further above, than the present folding decoy invention.

U.S. Pat. No. 2,536,338 issued on Jan. 2, 1951 to George C. Withey et al., titled “Folding Goose-Duck Decoy,” describes a multiple piece construction, with each piece being formed of a relatively thin sheet of material. The result more closely resembles the decoys of the Rauert '846 and Davis '787 U.S. Patents than the present folding decoy invention.

U.S. Pat. No. 2,662,327 issued on Dec. 15, 1953 to Niels P. Petersen, titled “Collapsible Decoy,” describes a decoy body formed of a pair of opposed flat panels, hinged together along their upper edges to form an inverted V-shape body configuration. However, the two opposed body sheets must be spread for deployment by a third sheet disposed laterally between the two outer sheets. Also, while the neck is adjustable relative to the body, it merely pivots about a pin through the upper forward portion of the body. Petersen does not disclose any means of folding any of the structure to provide different poses or postures for his decoy, as provided in the present folding decoy invention.

U.S. Pat. No. 2,723,480 issued on Nov. 15, 1955 to Albert T. Candy, titled “Knock-Down Duck Decoy Of A Silhouette Type,” describes a decoy formed of multiple sheet components, with two of the sheets being assembled by mutual slots to provide horizontal and vertical components. The result more closely resembles the decoy of the '711 U.S. Patent to Dewey, than the present folding decoy. Moreover, the head of the Candy decoy is formed of a three dimensional block of material, rather than being an extension of the neck plies, as in the present decoy.

U.S. Pat. No. 4,172,335 issued on Oct. 30, 1979 to Thomas E. Farmer, titled “Goose Decoy,” describes a multiple piece decoy construction, with the various components each formed of relatively thin sheet material. The body portion is wrapped over to form an inverted, generally U-shaped configuration, with the flat head and neck component secured thereto. The result more closely resembles the decoy of the '368 U.S. Patent to Kunselman, discussed further above, than the present folding decoy invention.

U.S. Pat. No. 4,251,937 issued on Feb. 24, 1981 to Orvin B. Curley, titled “Collapsible Two Specie Duck Or Goose Decoys,” describes a decoy formed of two separate sheets secured together by a separate hinge component at the mutual back or upper edges thereof. The two panels or sheets are patterned differently on opposite sides, enabling the Curley decoy to represent different species, depending upon which surfaces are deployed outwardly. The head and neck elements are pivotally attached to the body portions. The result more closely resembles the decoy of the '327 U.S. Patent to Petersen discussed further above, than the present decoy.

U.S. Pat. No. 4,318,240 issued on Mar. 9, 1982 to Gene C. Hillesland, titled “Convertible Decoys Assembled From And Collapsible To Flat Sheets,” describes decoys formed of a single sheet of material which is printed on opposite sides with different species markings. The body portion is rolled to form a three dimensional shape; no folds are disclosed. The result more closely resembles the decoys of the Kunselman '368 and Farmer '335 U.S. Patents, discussed further above, than the present decoy invention.

U.S. Pat. No. 4,893,428 issued on Jan. 16, 1990 to Kenneth M. Gagnon, Sr., titled “Self-Aligning Decoy,” describes a decoy having a hollow, molded body with a three dimensional shape. The body is mounted on a pivot which allows the decoy to swivel into the wind. The Gagnon, Sr. decoy is not formed of a single flat sheet of material and cannot be folded for deployment, storage, or for changing its posture or configuration, as provided by the present folding decoy invention.

U.S. Pat. No. 5,003,722 issued on Apr. 2, 1991 to Robert D. Berkley et al., titled “Flying Game Bird Decoys,” describes a multiple piece decoy formed of two separate thin, flat sheets of relatively flexible material, i.e., foam plastic sheet. The body and wing portions are laid out horizontally and suspended by a depending post. The result allows the device to move in the wind. The Berkley et al. decoy cannot be folded to hold different postures or poses, as can the present folding decoy, due to the extremely flexible material required for the flapping and flexing effects in a light breeze for the Berkley et al. decoy.

U.S. Pat. No. 5,144,764 issued on Sep. 8, 1992 to Timothy D. Peterson, titled “Decoy With Wind-Actuated Wings,” describes a decoy suspended on a stake, for actuation by the wind. The body comprises a generally cylindrical tube, similar to an aviation wind sock, while the wings are quite flexible in order to flap in the wind. The Peterson device is thus not sufficiently rigid as to maintain a predetermined pose after folding, and moreover, Peterson does not disclose any folds for his decoy.

U.S. Pat. No. 5,682,702 issued on Nov. 4, 1997 to Craig T. McKnight et al., titled “Collapsible Bird Decoy,” describes a decoy formed of a series of flat sheet components, secured together by means of mating slots. The result is more closely related to the decoys of the Dewey '711 and Candy '480 U.S. Patents discussed further above, than to the present folding decoy invention. Moreover, the wings of the McKnight et al. decoy are formed of very flexible material in order to flap in a breeze to simulate flight, as in the Berkley '722 and Peterson '764 U.S. Patents discussed further above. In contrast, the present decoy does not simulate a bird with its wings extended, but rather simulates a bird standing or roosting upon the surface with wings folded.

U.S. Pat. No. D-138,600 issued on Aug. 22, 1944 to William A. Ringler, titled “Floating Decoy Or Like Figure,” illustrates a design for a decoy having an inverted, generally U-shaped body with a relatively thick head portion extending therefrom. The Ringler decoy more closely resembles the decoys of the Kunselman '368 and Farmer '335 U.S. Patents, than it does the present decoy invention.

U.S. Pat. No. D-185,866 issued on Aug. 11, 1959 to Frank H. Anderson, titled “Decoy,” illustrates a design for a decoy having an inverted, generally U-shaped body portion with a three dimensional head and neck representation extending therefrom. The Anderson decoy thus more closely resembles the decoys of the Kunselman '368, Farmer '335, and Ringler '600 U.S. Patents, than it does the present decoy invention.

U.S. Pat. No. D-268,862 issued on May 3, 1983 to Chris Fulster, titled “Combined Duck Decoy And Stabilizers,” illustrates a design for a decoy having a three dimensional body with a series of fins or the like depending therefrom. No means of folding the Fulster decoy from a single sheet of laminated material is apparent, as is provided by the present folding decoy invention.

Finally, U.S. Pat. No. D-339,402 issued on Sep. 14, 1993 to Alberto Santos, Jr., titled “Decoy Body,” illustrates a design comprising a flat sheet which is rolled or wrapped to an inverted, generally U-shape to simulate the body of a game bird. No head or other components are provided in the Santos, Jr. design, other than the broken line suggestion of a head and neck in one drawing Figure. The Santos, Jr. design more closely resembles the decoy of the Hillesland '240 U.S. Patent, discussed further above, than the present folding decoy invention.

None of the above inventions and patents, either singly or in combination, is seen to describe the instant invention as claimed.

### SUMMARY OF THE INVENTION

The present invention comprises various embodiments of folding decoys or representations of animals of various types. Each of the embodiments is formed of a single sheet of laminated material, having opposite face sheets and a central core material sandwiched therebetween. Preferably, the material used has a corrugated core or other means providing greater stiffness in one direction than another.

Generally, decoys are constructed according to the present invention by cutting out a silhouette of the animal desired and forming a series of scores through one of the face sheets and the core material, leaving the opposite face sheet uncut. The material is then folded away from the scored side or surface, and toward the uncut face which acts as a hinge for the fold along the line opposite the cut. By forming these scores in a predetermined pattern through one or both faces of the laminated material a three dimensional representation of a game bird or other animal may be provided, with different score and fold lines providing for different folds to form different poses and postures for the animal.

Accordingly, it is a principal object of the invention to provide various embodiments of folding decoys or other animal representations, each formed of a single sheet of laminated material.

It is a further object of the invention to form folding decoy embodiments by cutting a planform silhouette and making a series of scores through one face sheet and the core of the sheet material, for folding the sheet material about the uncut opposite face sheet as desired to form a three dimensional shape.

Still another object of the invention is to provide different poses or postures for the decoys by selectively folding the sheet material along an appropriate series of score lines about the uncut opposite face sheet as desired to form the desired pose.

An additional object of the invention is to provide a method of constructing decoys of laminated sheet material, by cutting out a decoy body pattern from the material, selectively scoring the material, and selectively folding the material along selected score lines to form a decoy shape having a posture or pose as determined by the selected folds.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of the deployment of series of folding decoys according to the present invention, showing two alternate poses or configurations.

FIG. 2 is a top plan view of a cutout for a decoy of FIG. 1, showing the general configuration and a series of score and fold lines.

FIG. 3 is a decoy folded from the flat pattern of FIG. 2.

FIG. 4 is an alternative decoy posture folded from the flat pattern of FIG. 2, using different score and fold lines.

FIG. 5A is a flat pattern for forming a decoy or representation including legs generally normal to the body portion.

FIG. 5B shows the flat pattern of FIG. 5A with the leg portions folded according to the present invention for extension of the legs.

Similar reference characters denote corresponding features consistently throughout the attached drawings.

### DETAILED DESCRIPTION OF THE PREFERRED EMBODIMENTS

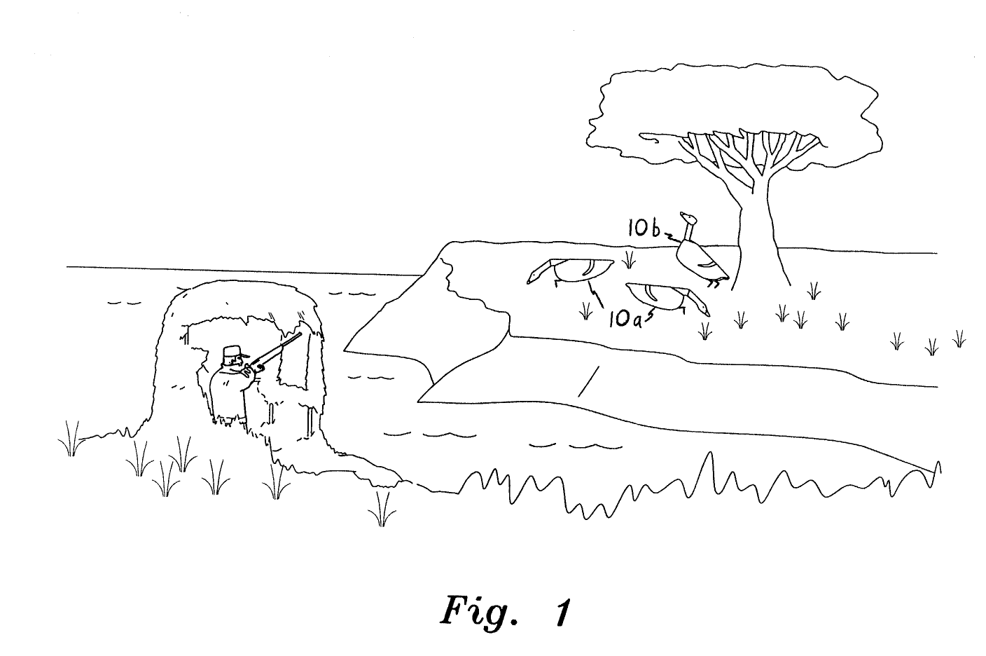

The present invention comprises various embodiments of folding decoys, and methods for folding such decoys as well. FIG. 1 of the drawings illustrates an environment in which the present decoys may be used, as in hunting. It will be noted that the decoys of FIG. 1 are designated as decoys 10a and 10b. This is due to the different poses or postures formed when folding the decoys 10a and 10b, and not due to any inherent differences between their structures. Each of the decoys 10a and 10b is formed from a single sheet of material, and includes a series of score lines enabling the hunter or other person to fold various portions of the decoy to form different poses or postures, as desired, thus precluding need to purchase several different models of decoys representing a given species in order to provide the desired realism in a given setting. In FIG. 1, two of the decoys 10a have been folded to represent birds having their necks lowered to have the appearance of feeding geese, while a third decoy 10b has been folded with the neck raised to take on the appearance of a “guard goose.” This is a realistic scenario, as a flock of geese will normally have at least one goose on alert with its head raised, while others feed.

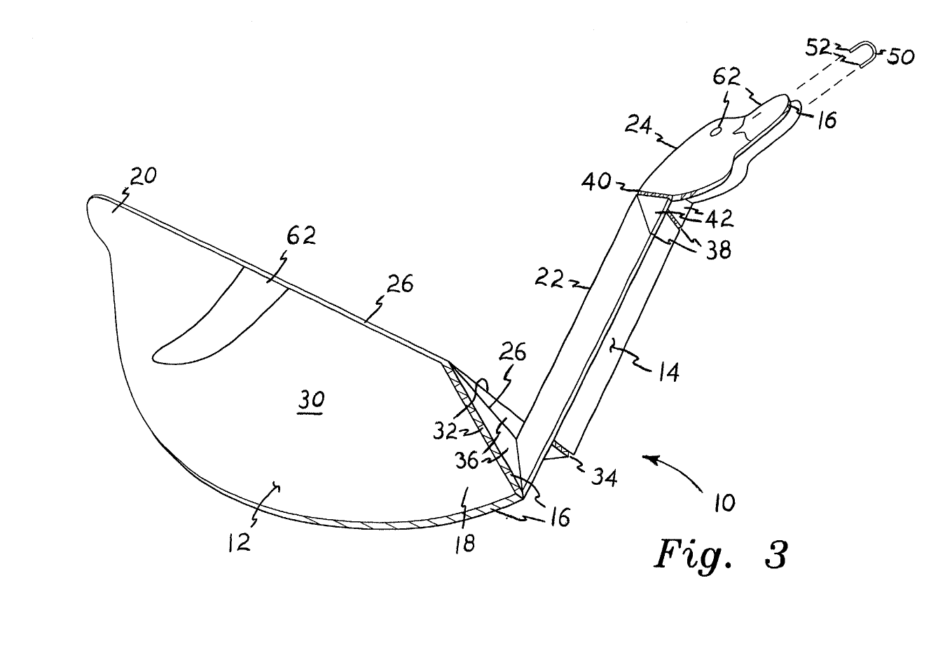

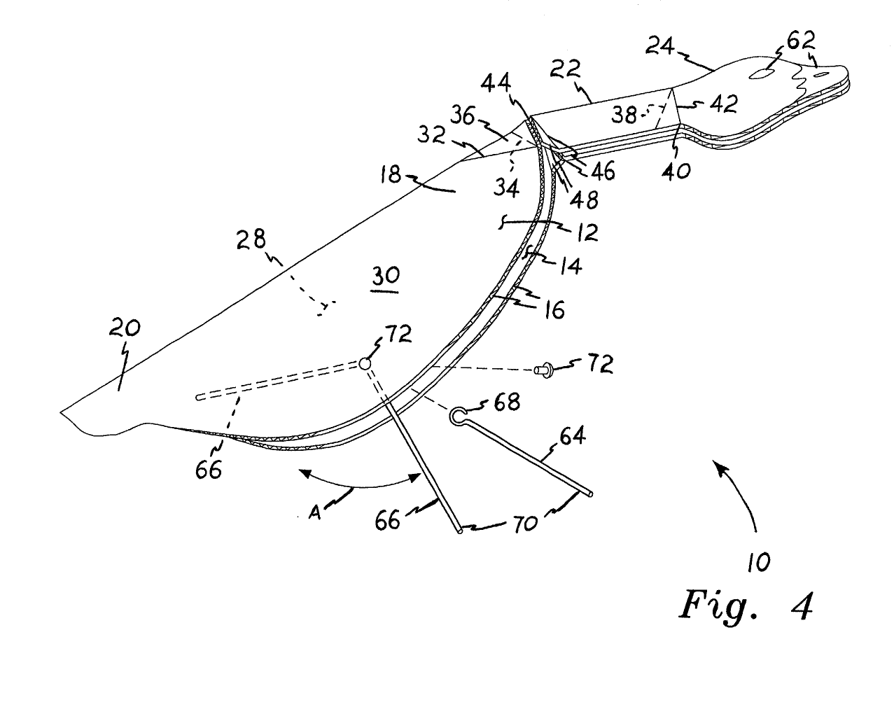

The body pattern for a decoy 10a, 10b, etc. is cut out from a single thickness of laminated sheet material to have a planform outline of the desired decoy animal (e. g., goose or other game bird, etc.). The laminated material is more clearly shown in FIGS. 3 and 4, and includes a first face ply 12, an opposite second face ply 14, and a core material 16 sandwiched between the two plies 12 and 14. Preferably, the core 16 is corrugated, with the laminate being relatively stiffer across the corrugations. The passages defined by the corrugations 16 provide other advantages as well, described further below. A corrugated laminate formed of waterproof plastic material, known as Coraplast™, has been found to work well in the construction of exemplary models of the present invention. However, other laminated materials, e. g., foam and honeycomb core laminates, etc., may also be used if so desired.

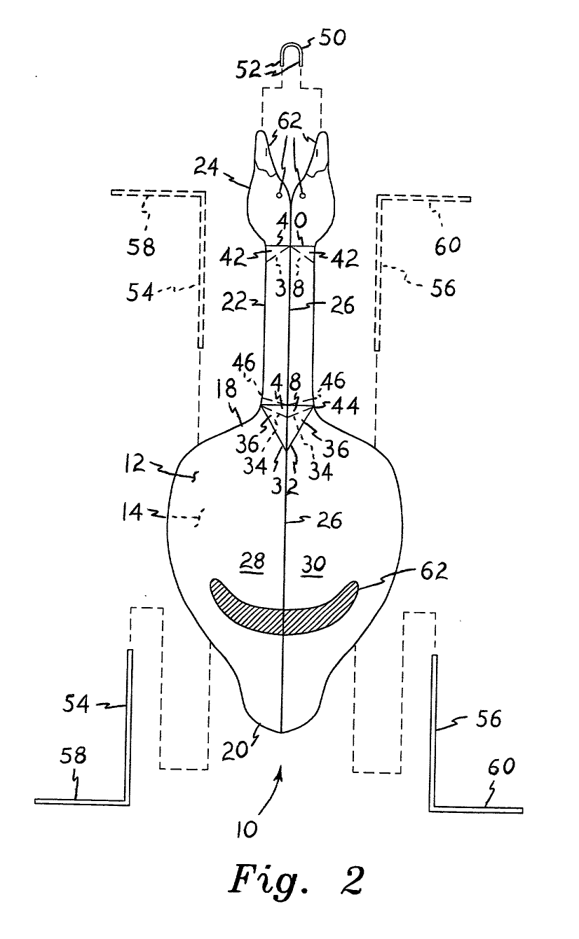

The decoy body pattern 10 of FIG. 2 has a forward end 18, an opposite rearward end 20, and a neck extension 22 with a head representation 24 at the distal end of the neck 22. The laminated sheet of the body pattern 10 is then scored, i. e., cut partially through, on opposite sides in order to provide fold lines for configuring the body pattern 10 in various poses as desired. These score lines are shown in FIG. 2 as solid lines when the viewed first face ply 12 is cut, and as broken lines when the opposite hidden surface 14 is cut. It will be understood that the score lines do not penetrate completely through the material, but cut through only one ply and the core, leaving the opposite ply intact to serve as a live hinge for the fold made along the score line.

The decoy body 10 planform cutout will be seen to be laterally symmetrical, with each side representing a profile view of the decoy animal. A longitudinal score 26 is made through the first ply 12 and core material 16, parallel to the corrugations 16 and extending from the forward end 18 to the rearward end 20 of the body 10. When a goose decoy 10 or the like is being made, the neck extension 22 extends along the longitudinal axis of the body 10 and is also scored along its centerline by the longitudinal score 26. This longitudinal score 26 “opens” the first face ply 12, allowing the opposite sides of the laminate sheet to be spread along the score 26 while the two sides are held together by the intact second face ply 14 on the opposite side of the longitudinal score 26. This allows the two panels 28 and 30 of the decoy body 10 to be folded toward the second face ply 14 to form an inverted, generally V-shaped cross section, generally as shown in FIGS. 1, 3, and 4 of the drawings.

Additional scores are provided angularly across various areas of the body 10, and particularly the neck extension 22, of the decoy 10. These angular scores are formed in pairs with the two scores of each pair being adjacent one another. One score of the pair is cut through the first face ply 12 and core 16, and the second score of the pair is cut through the opposite second face ply 14 and core 16. This enables the resulting two folds to be made in opposite directions or orientations from one another, thus resulting in the body or extension to each side of the score and fold pair remaining in the same general plane.

The two scores forming each score pair define a score angle therebetween, which when the laminate sheet is folded along each score of the score pair, results in an angle being formed between the resulting two body portions on each side of the score pair. As the material within the score angle, i. e., between each score of a score pair, is doubled over as the fold is made, it will be seen that the resulting angle between body portions is exactly twice the angle defined by the two scores of a given score pair. As an example, if it is desired to have some portion of the decoy extend at a sixty degree angle to another portion, then the two scores are made at an angle of thirty degrees to one another. A ninety degree angle between body portions requires a forty five degree angle between the two scores of a score pair, etc.

FIGS. 3 and 4 provide specific examples of the above described principle. In FIG. 3, a first angular score 32 is made at the forward end 18 of the body and through the first face ply 12, extending outwardly and forwardly to each side from the longitudinal score 26 to the base of the neck extension 22. A second angular score 34 is made across the base of the neck extension 22 from the opposite second face ply 14, extending slightly forwardly to each side from the central longitudinal score 26. (The above scores 32 and 34 extend symmetrically to each side of the longitudinal score 26, to provide symmetrical folding of the various components.) These two scores 32 and 34 define fold panels 36 therebetween, and preferably have an included angle of substantially forty five degrees therebetween.

These two scores 32 and 34 are folded away from their respective scores, resulting in the two fold panels 36 to each side of the longitudinal score 26 and adjacent the base of the neck extension 22, being folded inwardly with their first face ply surfaces facing one another. The upward folding of the neck extension 22 by means of the second scores 34, results in the base of the neck extension 22 folding into the valley defined by the two fold panels 36. It will be seen that if all of these panels are doubled over to lie against one another, that the doubling over of the two fold panels 36 results in the included angle between the score pair 32 and 34 being doubled. With a forty five degree included angle between the two scores 32 and 34, the result is that the neck extension portion 22 is folded upwardly ninety degrees to the axis of the body portion, defined by the longitudinal score 26.

The head portion 24 of the present folding decoy 10 may be configured in a similar manner, by providing third and fourth scores 38 and 40 comprising a second score pair at the base of the head portion 24 at its juncture with the neck extension 22. In this case, the third score 38 is cut through the second face ply 14 and core 16 and extends outwardly and rearwardly from the central longitudinal score 26, at a forty five degree angle thereto. The fourth score 40 is cut through the first face ply 12, and extends perpendicularly across the juncture of the neck extension 22 and head 24. The included fold panels 42 result in a ninety degree fold between the head 24 and neck extension 22, when the second score pair comprising scores 38 and 40 are folded.

The result is a folding decoy having the neck portion 22 turned upwardly essentially ninety degrees to the body portion, with the head portion 24 turned ninety degrees to the body portion so the longitudinal axis of the head 24 is generally parallel to the longitudinal axis of the body portion. While the configuration of FIG. 3 illustrates this folding in an intermediate stage, with the folding incomplete for clarity in the drawing Figure, the above described configuration will be seen to be that of the “guard goose” 10b illustrated in the environmental view of FIG. 1. A hunter, photographer, or other person wishing to attract geese, would likely wish to fold one of the present decoys to form such a pose, where several decoys are placed. A flock of geese typically have one or more of their members “on guard,” with the head and neck raised as in the decoy 10b of FIG. 1, while other geese in the flock have their heads and necks lowered for feeding. Folding a single (or perhaps two, for a larger flock) “guard goose” 10b, adds considerably to the realism of such a decoy flock.

However, most geese in a flock will have their heads and necks lowered for feeding, as in the goose decoys 10a of FIG. 1. Accordingly, another pair of scores 44 and 46 is provided at the base of the neck 22 at its juncture with the forward body portion 18, as shown best in FIG. 4. The first of these scores, i. e., score 44, extends across the base of the neck extension 22, perpendicular or normal to the longitudinal score 26. The second score 46 of this pair extends slightly forwardly, defining a slight angle (e. g., about fifteen degrees) between the two scores 44, 46.

The resulting included angle subtended by the third fold panel 48 between the two scores 44 and 46, results in the lowering of the neck extension 22 to an angle twice that of the included angle, or about thirty degrees relative to the body portion in this example. This head and neck lowered posture represents a feeding goose fairly realistically, as can be seen in FIG. 1 where two goose decoys 10a of the present invention have been folded to take on a head down, feeding posture. The angle between the two scores 44 and 46, or other score pairs of the present folding decoy invention, may be adjusted as desired during their cutting or scoring to adjust the angle between various components to any suitable angle desired.

Due to the relative thickness of the various folding panels of the folding decoy and the doubling of these panels in certain areas due to the folds made, as well as the resilience of the material along the “live hinge” areas opposite the scores, the panels comprising the present folding decoy will tend to spring back to a flat state, essentially as shown in FIG. 2 of the drawings. Accordingly, the present invention includes means for securing the panels in a folded state, as desired. In FIGS. 2 and 3, a generally U-shaped panel retainer 50 is provided for removably securing the two side panels 28 and 30 together. The stiffness of the decoy body 10 due to the elongate corrugations 16 running therethrough, allows a single such panel retainer 50 to secure the entire folded decoy configuration together as desired. However, an additional retainer(s) (not shown) may be used, if so desired.

The panel retainer 50 is formed of a relatively stiff wire rod having a diameter about the same as, or certainly no greater than, the lateral dimension of each of the corrugations 16. The two opposed ends 52 of the retainer 50 are inserted into adjacent corrugation passages between the first and second face plies 12 and 14 in adjacent folded panels of the folded decoy 10, thus holding the two adjacent panels together as desired. The relative stiffness provided by the longitudinally disposed corrugations 16, generally results in only a single such panel retainer 50 being required at the forward or head end 24 of the decoy 10, as shown in FIGS. 2 and 3 of the drawings. However, this panel retainer 50 (or multiple retainers 50) may be installed in other areas of the decoy as well, if so desired.

The longitudinally oriented corrugations 16 of the preferred laminated material from which the present decoy 10 is formed, provide an additional advantage for supporting the folded decoy in the field. FIG. 2 of the drawings illustrates the first and second supports 54 and 56 which may be provided with the present decoy 10, to support the decoy 10 in the field. The supports 54 and 56 are formed of wire rods having a diameter about the same as (but no greater than) the lateral spacing between corrugations 16 within the two face plies 12 and 14, in order to fit securely within any given corrugation passage.

As the corrugations 16 run parallel to the longitudinal axis of the decoy 10 body, i. e., parallel to the longitudinal score 26, the supports 54 and 56 must be inserted to run parallel to the longitudinal axis and score 26. Accordingly, each support 54 and 56 is generally L-shaped, with an extension at some angle to the portion which is inserted within the corrugations. These extensions 58 and 60 are inserted into the ground or underlying surface to support the decoy 10 in the desired position, as shown generally in FIG. 1 of the drawings.

In FIG. 2 the supports 54 and 56 are shown in solid lines at the rear portion 20 of the decoy 10, and in broken lines at the front portion 18 of the decoy 10. It will be seen that these supports 54, 56 may be installed in either end or portion of the decoy 10 as desired, to orient or pose the decoy 10 in the desired position. For example, in the environmental view of FIG. 1, the “guard goose” decoy 10b is posed or configured with the forward portion of the body raised somewhat, in keeping with the natural posture generally assumed by a real “guard goose” in a flock. Accordingly, the two supports 54, 56 have been installed to the rear portion of the body. In contrast, the two decoys 10b which appear to be feeding, would have the forward portions of their bodies lowered. In this pose, the supports 54 and 56 are inserted into the forward portion of the body, in order to hold the forward portion down. The use of relatively thin support rods provides an additional advantage, in that the surface area of the decoys allows them to move and sway in a slight breeze, for added realism.

FIG. 4 illustrates an alternative support structure for the present folding decoy 10. In FIG. 4, first and second supports, respectively 64 and 66, each have an attachment eye 68 formed in the attachment end thereof, with a straight distal end 70 extending oppositely therefrom. A pivotal attachment 72, such as a blind rivet (e. g., Pop Rivet™), mating nut and bolt, etc. is secured through each of the two panels 28 and 30 and through the attachment eyes 70 of each of the two supports 64 and 66. Washers (not shown) may be applied conventionally to protect the material of the panels 28 and 30, and distribute the load of the support attachment over a wider area of the panel material. These pivotally attached supports 64 and 66 are essentially permanently secured to their respective panels 28 and 30, and are selectively pivotable to fold beneath their respective panels 28 and 30 for storage or extendible for deployment of the decoy 10 as desired, as indicated by the arcuate folding and extension arrow A. Their permanent attachment to the decoy 10 assures that they cannot become misplaced or lost, and that they will always remain with the decoy 10.

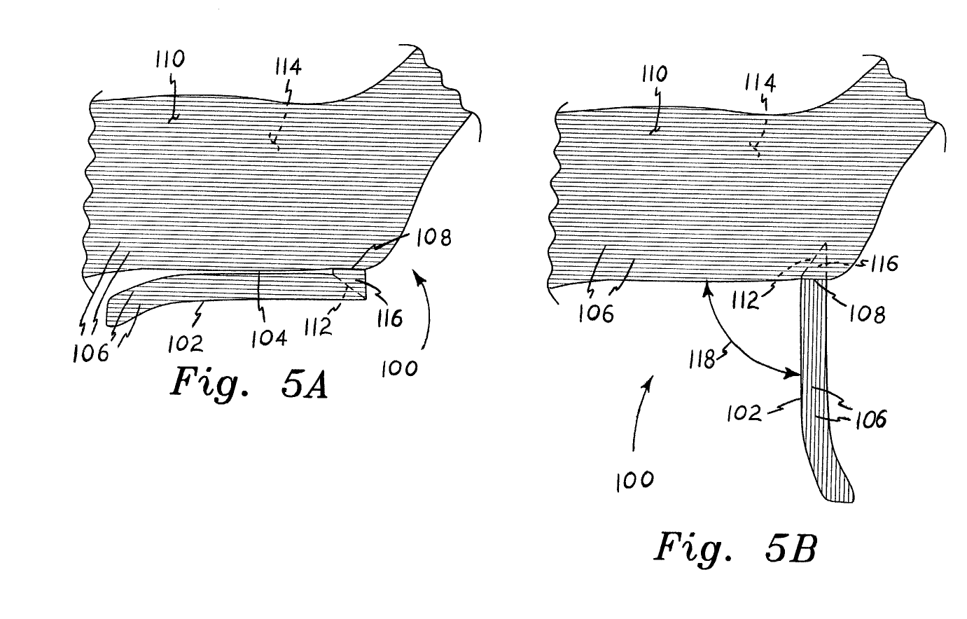

The present folding decoy invention may comprise other animal forms in addition to bird decoys, if so desired. It will be seen that the means of scoring and folding a body extension may be accomplished for extending and posing the legs of a four legged mammal or other animal type, as desired. FIGS. 5A and 5B of the drawings illustrate such an embodiment.

In FIG. 5A, a body trunk panel 100 is cut out in the shape of the desired animal (deer, etc; most of the animal representation and plural leg extensions are not shown in FIGS. 5A and 5B, in order to simplify the drawing Figures while clearly showing the principle involved). Leg extensions 102 are cut at this time as integral parts of the body trunk portion 100, separated from the trunk 100 by a slit 104 extending to the juncture of the leg 102 with the trunk 100. It will be noted that the leg extension 102 is generally parallel to the trunk portion 100, with corrugations 106 of the laminated trunk panel 100 being indicated as a series of parallel lines extending the length of the trunk portion 100 and the parallel leg 102. This initial pattern results in the corrugations 106 remaining generally parallel to the length of the legs 102, with the legs 102 thus having their greatest bending resistance in a direction along their length, where it is most critical for supporting the decoy or animal silhouette. Cutting a flat pattern decoy or animal silhouette with the legs extended, would result in the corrugations running across the legs, with relatively little bending resistance along the length of the legs where it is needed for support of the decoy or silhouette.

Once the general shape of the decoy 100 has been cut from the laminated panel, scores are made at the juncture of each leg 102 and the trunk portion 100. The first score 108 is made through the first face ply 110 and parallel to the corrugations 106, as indicated by the solid line in FIG. 5A, with the second score 112 being made in the opposite second face ply 114 to extend downwardly and forwardly at a generally forty five degree angle to the first score 108, as indicated by the broken line in FIG. 5A. These two score lines 108 and 112 define a generally triangular fold panel 116 therebetween, which is folded or tucked up when the leg 102 is extended.

The leg 102 is extended by first folding it inwardly, i. e., toward the second face ply 114 of the body panel 100. This results in the leg 102 being tucked up behind the trunk panel 100, but remaining parallel to the longitudinal axis of the trunk panel 100. Next, the leg 102 is folded forwardly and downwardly along the second or generally diagonal score 112, as indicated by the extension arrow 118 in FIG. 5B. This results in the leg extension 102 being deployed at an angle generally normal to the body or trunk portion 100, due to the doubling over of the forty five degree angle fold panel 116 and doubling of the forty five degree angle between the two scores 108 and 112. This means of extending leg portions for a four legged or other animal representation, results in the corrugations of the panel remaining parallel to the length of the leg, thereby providing additional strength to the leg for support of the animal representation.

In conclusion, the present folding decoy invention provides an economical, yet versatile means of attracting game birds and other animals for hunting, photography, and/or other purposes as desired. While the present decoys do not provide the detailed realism of carefully modeled three dimensional molded decoys, the present decoys provide sufficient realism to be believable at a reasonably great distance, i. e., a few hundred yards or more. This is generally sufficient to attract animals into gun or camera range, i particularly with a long lens for the camera. Additional realism is provided by means of eye, beak, and/or coloring representation 62 (shown in FIGS. 2 through 4), in the form of paint, decals, and/or other marking or coloring means as desired. The realism of the present decoys is further enhanced by their ability to be posed in different postures by selectively folding along appropriate scores provided through opposite face plies of the laminate sheet from which the decoys are made. The placement of a series of decoys set in different postures, rather than all having the same posture, adds greatly to the realism attainable using the present folding decoy invention.

The present folding decoys provide numerous additional advantages, in addition to their economy and versatility. They are easily readied for storage, by removing any panel retainers from the front or other portion of the decoy panel, and laying a series of such panels flat atop one another. Alternatively, the panels may remain in a folded V configuration along their longitudinal scores, and stacked atop one another in that configuration.

The preferred Coraplast™ material from which the present decoys are constructed, provides numerous advantages as well. The waterproof plastic nature of the material results in little, if any, deterioration after prolonged use in the field in damp or wet conditions. This is an especially critical point for waterfowl decoys, as in the goose decoy 10 disclosed herein. The use of a corrugated material provides further advantages, in that the corrugations contribute to the strength and bending resistance of the material in the direction of the corrugations, and further the slots or channels between corrugation elements provides for the removable insertion of panel retainers for holding the panels in a folded condition, and/or the removable insertion of support rods or members to position the decoys realistically. While the use of support rods in the embodiment of FIGS. 5A and 5B is not shown, it will be seen that straight sections of such supports could be inserted in the distal ends of the leg members for setting in the ground, due to the elongate orientation of the corrugations in the leg extensions of that decoy or animal representation. Thus, the present decoy invention will prove quite popular for use by hunters, photographers, and others who have occasion or need to attract waterfowl and/or other birds and animals for any purpose.

It is to be understood that the present invention is not limited to the embodiments described above, but encompasses any and all embodiments within the scope of the following claims.

I claim:

1. A folding decoy, comprising:
a body formed of a single sheet of laminated material and having a forward end, a rearward end opposite said forward end, and at least one extension;
said laminated material having a thickness, a first face ply, a second face ply opposite said first face ply, and a core sandwiched therebetween;
said laminated material further having a longitudinal score through said first face ply and said core, and extending at least from said forward end to said rearward end of said body for folding said body about said second face ply opposite said longitudinal score and forming an inverted, generally V-shaped configuration having a first panel and a second panel opposite thereto;
said laminated material further having at least a first angular score through said first face ply and core and at least a second angular score through said second face ply and core;
said first angular score and said second angular score disposed adjacent one another, and defining a score angle therebetween; and
said laminated material further being selectively folded along said first angular score and said second angular score for selectively forming a first portion and a second portion having a fold angle therebetween, with said fold angle being twice said score angle.

2. The folding decoy according to claim 1 wherein said core of said laminated material comprises a plurality of elongate corrugations disposed parallel to said longitudinal score, the decoy further including:
a first support and a second support, each said support comprising a wire rod having a diameter no greater than each of said corrugations of said laminated material, each said support being removably inserted into and parallel to one of said corrugations of said laminated material between said first face ply and said second face ply for supporting said body.

3. The folding decoy according to claim 1 wherein said core of said laminated material comprises a plurality of elongate corrugations disposed parallel to said longitudinal score, further including:
a panel retainer, said panel retainer comprising a wire rod having a generally U-shaped configuration with a diameter slightly less than each of said corrugations of said laminated material, said panel retainer being removably inserted into and parallel to one of said corrugations of said laminated material of one said end of said body between said first face ply and said second face ply for removably securing said first panel and said second panel together.

4. The folding decoy according to claim 1, further including:
a first support and a second support depending respectively from said first panel and said second panel; and
means permanently and pivotally securing each said support to the respective said panel, for selectively folding each said support thereunder for storage and for extending therefrom for deployment.

5. The folding decoy according to claim 1, wherein:
said laminated material is a waterproof plastic; and
said core of said laminated material is selected from the 4 group consisting of laminates having a honeycomb core structure and laminates having a rigid foam core.

6. The folding decoy according to claim 1, wherein:
said body comprises a waterfowl representation;
said extension comprises the head and the neck of said waterfowl representation;
said first angular score and said second angular score are disposed upon said neck of said waterfowl representation, adjacent said forward end of said body; and
said body portion angle comprises an angle between said neck and said forward end of said body of said waterfowl representation.

7. The folding decoy according to claim 1, wherein said body further includes a trunk portion, with said at least one extension comprising a plurality of leg members disposed generally parallel to said trunk portion when said body is in an unfolded condition;
said first angular score and said second angular score being disposed upon each of said leg members adjacent said trunk portion, with an angle of generally forty five degrees therebetween; and
said laminated material further being folded along each said first angular score and each corresponding said second angular score for extending each of said leg members generally normal to said trunk portion of said body.

8. A folding decoy, comprising:
a body formed of a single sheet of laminated material and having a forward end, a rearward end opposite said forward end, and at least one extension;
said laminated material having a thickness, a first face ply, a second face ply opposite said first face ply, and a core sandwiched therebetween;
said laminated material further having a longitudinal score through said first face ply and said core, and extending at least from said forward end to said rearward end of said body for folding said body about said second face ply opposite said longitudinal score and forming an inverted, generally V-shaped configuration having a first panel and a second panel opposite thereto; and
a first support and a second support attached to said body.

9. The folding decoy according to claim 8, wherein:
said core of said laminated material comprises a plurality of elongate corrugations disposed parallel to said longitudinal score;
each said support comprises a wire rod having a diameter slightly less than said thickness of said laminated material; and
each said support is removably inserted into and parallel to one of said corrugations of said laminated material between said first face ply and said second face ply for supporting said body.

10. The folding decoy according to claim 8, wherein:
each said support comprises a wire rod permanently and pivotally secured to said first panel and to said second panel and depending respectively therefrom, each said support selectively folding each said support thereunder for storage and extending therefrom for deployment.

11. The folding decoy according to claim 8, wherein said core of said laminated material comprises a plurality of elongate corrugations disposed parallel to said longitudinal score, the decoy further including:
a panel retainer, said panel retainer comprising a wire rod having a generally U-shaped configuration with a diameter slightly less than each of said corrugations of said laminated material, said retainer being removably inserted into and parallel to one of said corrugations of said laminated material of one said end of said body between said first face ply and said second face ply for removably securing said first panel and said second panel together.

12. The folding decoy according to claim 8, wherein:
said laminated material is a waterproof plastic; and
said core of said laminated material is selected from the group consisting of laminates having a honeycomb core structure and laminates having a rigid foam core.

13. The folding decoy according to claim 8, wherein:
said body comprises a waterfowl representation;
said extension comprises the head and the neck of said waterfowl representation;
said laminated material further has at least a first angular score through said first face ply and said core and at least a second angular score through said second face ply and said core;
said first angular score and said second angular score are disposed adjacent one another upon said neck of said waterfowl representation, adjacent said forward end of said body, and define a score angle therebetween, said laminated material further being selectively folded along said first angular score and said second angular score for selectively forming a first portion and a second portion having a fold angle therebetween, with said fold angle being twice said score angle; and
said fold angle comprises an angle between said neck and said forward end of said body of said waterfowl representation.

14. The folding decoy according to claim 8, wherein:
said body includes a trunk portion;
said at least one extension comprises a plurality of leg members disposed generally parallel to said trunk portion when said body is in an unfolded condition; and
said first angular score and said second angular score are disposed upon each of said leg members adjacent said trunk portion, with an angle of generally forty five degrees therebetween, said laminated material further being folded along each said first angular score and each corresponding said second angular score for extending each of said leg members generally normal to said trunk portion of said body.

15. A method of forming a folding decoy, comprising the steps of:
(a) providing a single flat sheet of laminated material having a thickness, a first face ply, a second face ply opposite said first face ply, and a core sandwiched therebetween;
(b) cutting a decoy body pattern from the sheet of laminated material, and defining a forward end and a rearward end of the body pattern;
(c) scoring the body pattern longitudinally through the first face ply and core, at least from the forward end to the rearward end of the body pattern;
(d) further scoring the body pattern with at least a first angular score through the first face ply and core and at least a second angular score through the second face ply and core, with the first and second angular scores disposed across the longitudinal score and adjacent one another, and defining a score angle therebetween;
(e) folding the body pattern about the second face ply opposite the longitudinal score and forming an inverted, generally V-shaped configuration for the body pattern, having a first panel and a second panel opposite thereto; and
(f) selectively folding the body pattern along the first score and second score and thereby selectively forming a first portion and a second portion having a fold angle therebetween, with the fold angle being twice the score angle.

16. The method of forming a folding decoy according to claim 15, further including the steps of:
(a) providing a plurality of elongate corrugations disposed parallel to the longitudinal score of the laminated material, for the core of the laminated material;
(b) forming a first support and a second support of wire rod, material having a diameter slightly less than each of the corrugations of the laminated material; and
(c) supporting the body by removably inserting each support into and parallel to one of the corrugations of the laminated material between the first face ply and the second face ply, and adjusting the supports as required.

17. The method of forming a folding decoy according to claim 15, further including the steps of:
(a) providing a plurality of elongate corrugations disposed parallel to the longitudinal score of the laminated material, for the core of the laminated material;
(b) forming a panel retainer of a wire rod having a generally U-shaped configuration with a diameter slightly less than each of the corrugations of the laminated material; and
(c) removably securing said first panel and said second panel together by removably inserting the panel retainer into and parallel to one of the corrugations of the laminated material between the first and the second face plies.

18. The method of forming a folding decoy according to claim 15, further including the steps of:
(a) forming a first support and a second support of wire rod material;
(b) forming an attachment eye in one end of each support; and
(c) permanently and pivotally securing each support to a respective panel by means of a respective support attachment eye, for selectively folding each said support thereunder for storage and extending therefrom for deployment.

19. The method of forming a folding decoy according to claims 15, further including the step of selecting the laminated material from the group consisting of waterproof plastic laminates having a honeycomb core and waterproof plastic laminates having a rigid foam core.

20. The method of forming a folding decoy according to claim 15, further including the steps of:
(a) cutting the decoy body pattern to represent a waterfowl;
(b) configuring the extension of the body pattern to represent the head and the neck of the waterfowl representation;
(c) scoring the neck of the waterfowl representation adjacent the forward end of the body, for making the first and second angular scores; and
(d) folding the body portion at the first and second angular scores to form an angle between the neck and the forward end of the body of the waterfowl representation.
